(19) United States
(12) Patent Application Publication
(10) Pub. No.: US 2020/0339444 A1
(43) Pub. Date: Oct. 29, 2020

(54) AERATION AMOUNT CONTROL SYSTEM AND AERATION AMOUNT CONTROL METHOD

(71) Applicant: Mitsubishi Electric Corporation, Chiyoda-ku (JP)

(72) Inventors: Wataru YOSHIDA, Chiyoda-ku (JP); Yoshifumi HAYASHI, Chiyoda-ku (JP); Eiji IMAMURA, Chiyoda-ku (JP); Seiji NODA, Chiyoda-ku (JP)

(73) Assignee: Mitsubishi Electric Corporation, Chiyoda-ku (JP)

(21) Appl. No.: 16/958,956

(22) PCT Filed: Feb. 27, 2018
(86) PCT No.: PCT/JP2018/007068

§ 371 Date: Jun. 29, 2020

(51) Int. Cl. C02F 1/44; B01D 65/02

(52) U.S. Cl. CPC C02F 1/441; B01D 2321/04; B01D 2315/06; B01D 65/02

(57) ABSTRACT

An aeration amount control system includes a control device for determining a first target aeration amount as the target aeration amount, and after having determined the first target aeration amount, determining a second target aeration amount as the target aeration amount, wherein, if a first change amount of the transmembrane pressure difference of the separation membrane calculated by the measurement device for the aeration performed on the basis of the first target aeration amount by the aeration device is greater than a second change amount of the transmembrane pressure difference of the separation membrane calculated by the measurement device for the aeration performed on the basis of the second target aeration amount by the aeration device, the control device determines a value, smaller than the second target aeration amount, as a third target aeration amount.

### TECHNICAL FIELD

The present invention relates to an aeration amount control system and an aeration amount control method using a separation membrane.

### BACKGROUND ART

As a method for treating drained water containing organic substances (hereinafter, referred to as “treatment target water”), a membrane bioreactor (MBR) is used in which organic substances in treatment target water are decomposed using microorganisms and the treatment target water is separated into solid and liquid by a separation membrane. In filtering using the separation membrane, as the separation membrane continues to be used, contaminants adhere to the surface of the separation membrane and into the pores thereof and thus clogging (fouling) may occur, whereby filtering performance gradually deteriorates.

In the membrane bioreactor, an aeration device is provided under the separation membrane in order to suppress reduction in filtering performance due to fouling of the separation membrane. The aeration device provided under the separation membrane performs aeration with air or the like toward the separation membrane, to peel the adhering materials on the separation membrane surface by bubbles and ascending flow of treatment target water. The energy cost needed for aeration by the aeration device is estimated to reach approximately half the whole operating cost of the aeration amount control system. Accordingly, technology for reducing the amount of aeration by the aeration device is required.

Patent Document 1 proposes, as a membrane separation device operation method, a method in which the transmembrane pressure difference of the separation membrane is measured and the aeration amount is controlled so that the transmembrane pressure difference is kept at a predetermined increase speed set in advance. Specifically, in the membrane separation device operation method described in Patent Document 1, a target value for the aeration amount is increased at a constant rate on the basis of a difference between a reference value and a measured value for the transmembrane pressure difference.

### CITATION LIST

### Patent Document

Patent Document 1: Japanese Laid-Open Patent Publication No. 2013-202472

### SUMMARY OF THE INVENTION

### Problems to be Solved by the Invention

However, in the membrane separation device operation method described in Patent Document 1, while the target value for the aeration amount is increased at a predetermined constant rate, there is a possibility that the aeration amount exceeds an aeration amount needed for suppressing fouling. In the case where the increased target value exceeds the aeration amount needed for suppressing fouling, there is room for reduction in the energy cost needed for aeration by the aeration device.

The present invention has been made to solve the above problem, and an object of the present invention is to obtain an aeration amount control system and an aeration amount control method that enable reduction in operating cost for the aeration amount control system.

### Solution to the Problems

An aeration amount control system according to the present invention is an aeration amount control system for performing aeration for a separation membrane in a membrane separation tank storing treatment target water on the basis of a target aeration amount, the aeration amount control system including: a control device for determining a first target aeration amount as the target aeration amount, and after having determined the first target aeration amount, determining a second target aeration amount as the target aeration amount; an aeration device for performing the aeration by supplying gas on the basis of the target aeration amount determined by the control device; and a measurement device for calculating a change amount of a transmembrane pressure difference of the separation membrane with respect to the gas supplied by the aeration device, wherein, if a first change amount of the transmembrane pressure difference of the separation membrane calculated by the measurement device for the aeration performed on the basis of the first target aeration amount by the aeration device is greater than a second change amount of the transmembrane pressure difference of the separation membrane calculated by the measurement device for the aeration performed on the basis of the second target aeration amount by the aeration device, the control device determines a value smaller than the second target aeration amount, as a third target aeration amount.

Another aeration amount control system according to the present invention is an aeration amount control system for performing aeration for a plurality of separation membranes in a membrane separation tank storing treatment target water on the basis of a target aeration amount, the aeration amount control system including: a control device for determining a first target aeration amount as the target aeration amount; an aeration device for performing the aeration by supplying gas on the basis of the target aeration amount determined by the control device; and a measurement device for calculating change amounts of transmembrane pressure differences of the plurality of separation membranes with respect to the gas supplied by the aeration device, wherein, if a difference between respective first change amounts of the transmembrane pressure differences of the plurality of separation membranes during the aeration performed on the basis of the first target aeration amount by the aeration device, calculated by the measurement device, is smaller than a threshold, the control device determines a value smaller than the first target aeration amount, as a second target aeration amount.

An aeration amount control method according to the present invention is an aeration amount control method for performing aeration for a separation membrane in a membrane separation tank storing treatment target water on the basis of a target aeration amount, the aeration amount control method including: an aeration amount determination step of determining a first target aeration amount as the target aeration amount, and after having determined the first target aeration amount, determining a second target aeration amount as the target aeration amount; an aeration step of performing the aeration by supplying gas on the basis of the target aeration amount determined in the aeration amount determination step; and a change amount calculation step of calculating a change amount of a transmembrane pressure difference of the separation membrane with respect to the gas supplied in the aeration step, wherein, if a first change amount of the transmembrane pressure difference of the separation membrane calculated for the aeration performed on the basis of the first target aeration amount is greater than a second change amount of the transmembrane pressure difference of the separation membrane calculated for the aeration performed on the basis of the second target aeration amount, a value smaller than the second target aeration amount is determined as a third target aeration amount.

Another aeration amount control method for performing aeration for a plurality of separation membranes in a membrane separation tank storing treatment target water on the basis of a target aeration amount, the aeration amount control method including: an aeration amount determination step of determining a first target aeration amount as the target aeration amount; an aeration step of performing the aeration by supplying gas on the basis of the target aeration amount determined in the aeration amount determination step; and a change amount calculation step of calculating change amounts of transmembrane pressure differences of the plurality of separation membranes with respect to the gas supplied in the aeration step, wherein, if a difference between respective first change amounts of the transmembrane pressure differences of the plurality of separation membranes during the aeration performed on the basis of the first target aeration amount is smaller than a threshold, a value smaller than the first target aeration amount is determined as a second target aeration amount.

### Effect of the Invention

The aeration amount control system according to the present invention enables reduction in energy cost needed for aeration through increase/decrease of the target value for the aeration amount, and thus can reduce the whole operating cost of the aeration amount control system.

The aeration amount control method according to the present invention enables reduction in energy cost needed for aeration through increase/decrease of the target value for the aeration amount, and thus can reduce the whole operating cost of the aeration amount control system.

### BRIEF DESCRIPTION OF THE DRAWINGS

FIG. 1 is a configuration diagram of an aeration amount control system according to embodiment 1 of the present invention.

FIGS. 2A and 2B show an example of the configurations of a change amount calculation unit and a control device of the aeration amount control system according to embodiment 1 of the present invention.

FIG. 3 is a control flowchart in the aeration amount control system according to embodiment 1 of the present invention.

FIG. 4 is a graph illustrating the relationship between a transmembrane pressure difference and an aeration amount in the aeration amount control system according to embodiment 1 of the present invention.

FIG. 5 is a control flowchart in the aeration amount control system according to embodiment 1 of the present invention.

FIG. 6 is a configuration diagram of an aeration amount control system according to embodiment 2 of the present invention.

FIG. 7 is a control flowchart in the aeration amount control system according to embodiment 2 of the present invention.

FIG. 8 is a configuration diagram of an aeration amount control system according to embodiment 3 of the present invention.

### DESCRIPTION OF EMBODIMENTS

Hereinafter, embodiments of an aeration amount control system and an aeration amount control method according to the present disclosure will be described in detail with reference to the accompanying drawings. It is noted that the embodiments shown below are merely examples and the present invention is not limited to these embodiments.

### Embodiment 1

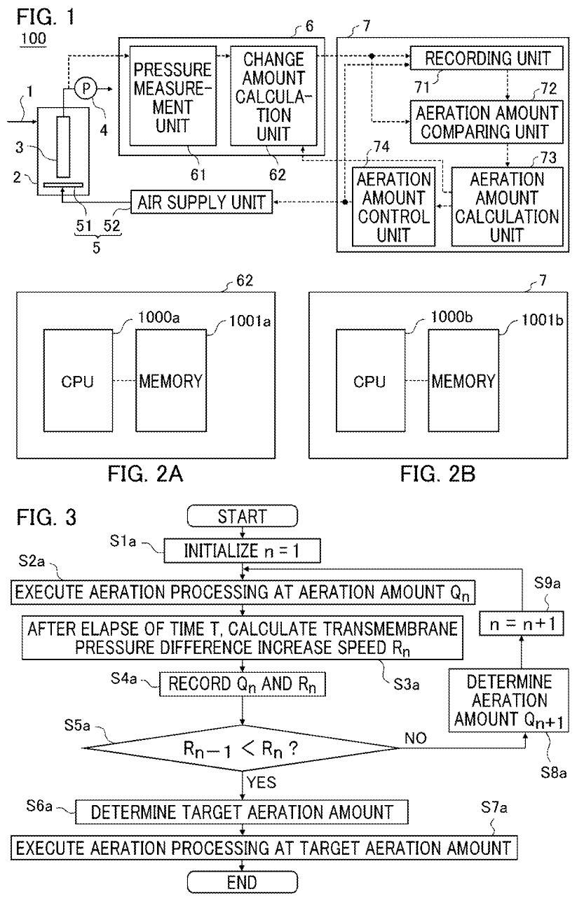

FIG. 1 is a configuration diagram of an aeration amount control system 100 according to embodiment 1. As shown in FIG. 1, the aeration amount control system 100 includes a membrane separation tank 2 into which treatment target water 1 flows, a separation membrane 3 which is provided so as to be immersed in the treatment target water 1 in the membrane separation tank 2 and filters the treatment target water 1 in the membrane separation tank 2, a filtration pump 4 for sucking treated water filtered by the separation membrane 3, an aeration device 5 for performing aeration for the treatment target water 1 toward the separation membrane 3, a measurement device 6 for measuring a change amount of the transmembrane pressure difference of the separation membrane 3, and a control device 7 for controlling the aeration amount of the aeration device 5.

The membrane separation tank 2 is configured such that the treatment target water 1 flows into the membrane separation tank 2, and a filtered water pipe (not shown) for draining treated water via the separation membrane 3 is connected to the membrane separation tank 2. The membrane separation tank 2 is formed from a material that can receive the treatment target water 1 and store the treatment target water 1, and is formed from, for example, concrete, stainless, or resin.

The separation membrane 3 separates the treatment target water 1 into solid and liquid. The separation into solid and liquid means that the treatment target water is separated into contaminants and treated water. The separation membrane 3 is provided so as to be immersed in the treatment target water 1 in the membrane separation tank 2, and is connected to the filtration pump 4 via the filtered water pipe. The filtration pump 4 sucks the treatment target water 1 in the membrane separation tank 2. The aeration amount control system 100 removes contaminants in the treatment target water by the separation membrane 3, to obtain treated water.

The separation membrane 3 is formed from a material such as a hollow fiber membrane or a flat membrane that can separate solid and liquid from each other, and is formed from, for example, a reverse osmosis (RO) membrane, a nanofiltration (NF) membrane, an ultrafiltration (UF) membrane, or a microfiltration (MF) membrane.

The aeration device 5 is provided under the separation membrane 3, and includes an aeration pipe 51 having a plurality of aeration pores for performing aeration for the treatment target water 1 toward the separation membrane 3, and an air supply unit 52 for supplying gas to the aeration pipe 51.

The aeration device 5 performs aeration with gas such as air from the aeration pipe 51 provided under the separation membrane 3, to peel adhering materials on the surface of the separation membrane 3 by bubbles and ascending flow of the treatment target water 1 caused by the bubbles, thereby suppressing fouling of the separation membrane 3. The aeration amount per membrane area of the separation membrane 3 is controlled to be 0.01 to 10 (m³/hr/m²).

The air supply unit 52 is connected to the control device 7, and supplies gas to the aeration pipe 51 on the basis of output from the control device 7.

As the separation membrane 3 continues separation into solid and liquid, it becomes impossible to completely remove the contaminants adhered and deposited on the separation membrane 3 through aeration by the aeration device 5. In order to remove the contaminants adhered and deposited on the separation membrane 3 which cannot be completely removed through aeration by the aeration device 5, reverse washing by ozone water, sodium hypochlorite, or the like is performed toward the separation membrane 3. The contaminants adhered and deposited on the surface of the separation membrane 3 and in the pores thereof are discharged through the reverse washing. In addition, microorganisms adhered and deposited on the surface of the separation membrane 3 and in the pores thereof are sterilized through the reverse washing. The separation membrane 3 is washed when the transmembrane pressure difference reaches a predetermined value, e.g., 25 kPa.

The measurement device 6 measures a change amount of the transmembrane pressure difference of the separation membrane 3. The measurement device 6 is provided to the filtered water pipe between the separation membrane 3 and the filtration pump 4, and includes a pressure measurement unit 61 for measuring the transmembrane pressure difference of the separation membrane 3, and a change amount calculation unit 62 for calculating the change amount of the transmembrane pressure difference per unit time on the basis of the transmembrane pressure difference measured by the pressure measurement unit 61. The transmembrane pressure difference is a pressure difference between the primary side, i.e., the unpassed water side and the secondary side, i.e., the passed water side of the separation membrane 3.

The measurement device 6 can recognize the degree of fouling in the separation membrane 3 on the basis of the transmembrane pressure difference value from the pressure measurement unit 61. As the membrane filtration is continued, the separation membrane 3 is gradually clogged and the transmembrane pressure difference increases. The pressure measurement unit 61 is an instrument capable of measuring the transmembrane pressure difference, and may be a digital type or an analog type. Further, the measurement device 6 is provided with any storage medium such as a flexible disc, a CD-ROM, or a memory card that can store the transmembrane pressure difference measured by the pressure measurement unit 61.

The change amount calculation unit 62 calculates the change amount of the transmembrane pressure difference per unit time on the basis of the transmembrane pressure difference measured by the pressure measurement unit 61, and outputs the calculated change amount of the transmembrane pressure difference per unit time to the control device 7. In embodiment 1, the change amount of the transmembrane pressure difference per unit time is calculated as a transmembrane pressure difference increase speed. The transmembrane pressure difference increase speed is a speed at which the transmembrane pressure difference increases per unit time. The change amount calculation unit 62 can be implemented through software control by a CPU 1000a executing a program stored in a memory 1001a as shown in FIG. 2A, for example. The pressure measurement unit 61 may be an instrument that measures only the pressure in the filtered water pipe, and the transmembrane pressure difference may be calculated by the change amount calculation unit 62.

The control device 7 controls the aeration amount of the aeration device 5. In addition, the control device 7 controls the aeration amount of the aeration device 5 on the basis of the measurement value from the measurement device 6. The control device 7 can be implemented through software control by a CPU 1000b executing a program stored in a memory 1001b as shown in FIG. 2B, for example.

The control device 7 includes a recording unit 71, a change amount comparing unit 72, an aeration amount calculation unit 73, and an aeration amount control unit 74.

The recording unit 71 is connected to the change amount calculation unit 62 and the aeration amount control unit 74. The recording unit 71 records, as aeration amount information, the change amount of the transmembrane pressure difference per unit time calculated by the change amount calculation unit 62, and the aeration amount subjected to aeration control by the aeration amount control unit 74 when the change amount is calculated, in association with each other.

The change amount comparing unit 72 compares a first change amount which is the change amount of the transmembrane pressure difference per unit time recorded in the recording unit 71, and a second change amount which is the change amount of the transmembrane pressure difference per unit time calculated by the change amount calculation unit 62 after calculation of the first change amount. The change amount comparing unit 72 calculates an aeration amount calculation command and outputs the calculated aeration amount calculation command to the aeration amount calculation unit 73. The aeration amount calculation command is information which includes a result of comparison of the change amounts by the change amount comparing unit 72 and which is used for the aeration amount calculation unit 73 to calculate the aeration amount.

The aeration amount calculation unit 73 calculates a target aeration amount for the aeration device 5 on the basis of the received aeration amount calculation command, and outputs the target aeration amount to the aeration amount control unit 74. As a result of comparison by the change amount comparing unit 72, if the first change amount is greater than the second change amount, the aeration amount calculation unit 73 calculates, as the target aeration amount, an aeration amount decreased by a predetermined amount or a predetermined rate from the aeration amount recorded in association with the second change amount in the recording unit 71. It is desirable that the decrease amount of the aeration amount is in a range of 0.01 to 5 (m³/hr/m²), and it is desirable that the decrease rate of the aeration amount is in a range of 10 to 50%. As a result of comparison by the change amount comparing unit 72, if the first change amount is smaller than the second change amount, the aeration amount calculation unit 73 calculates, as the target aeration amount, an aeration amount increased by a predetermined amount or a predetermined rate from the aeration amount recorded in association with the second change amount in the recording unit 71. It is desirable that the increase amount or the increase rate for the aeration amount is in the same range as the decrease amount or the decrease rate for the aeration amount. In addition, when a certain period has elapsed since calculation of the target aeration amount and a timing for calculating the next target aeration amount has come, the aeration amount calculation unit 73 outputs, to the change amount calculation unit 62, a change amount calculation command for causing the change amount calculation unit 62 to calculate the change amount of the transmembrane pressure difference per unit time during the certain period from calculation of the target aeration amount.

The aeration amount control unit 74 controls the amount of gas to be supplied by the air supply unit 52, on the basis of the aeration amount calculated by the aeration amount calculation unit 73, to cause the aeration device 5 to execute aeration. Examples of the control for the air supply unit 52 by the aeration amount control unit 74 include inverter control. In addition, the aeration amount control unit 74 transmits the aeration amount at the time when the change amount is calculated by the change amount calculation unit 62, to the recording unit 71. The function of transmitting the aeration amount to the recording unit 71 may be imparted to the aeration amount calculation unit 73.

FIG. 3 is a control flowchart in the aeration amount control system 100. The aeration amount control method in the aeration amount control system 100 will be described with reference to the control flowchart shown in FIG. 3.

While the aeration amount control system 100 executes the aeration amount control, the filtration pump 4 continuously sucks the treatment target water 1 in the membrane separation tank 2. When the filtration process by the aeration amount control system 100 is started, in initialization step S1a, the control device 7 initializes n to 1. Next, in aeration step S2a, the aeration amount calculation unit 73 executes aeration at an aeration amount Q₁ set in advance as a first target aeration amount. As the first target aeration amount Q₁, an optional value is employed from an appropriate range of the aeration amount that enables suppression of fouling of the separation membrane 3. For example, the first target aeration amount Q₁ is set to the maximum flow amount of the aeration device 5.

In change amount calculation step S3a, when time T₁ has elapsed since the start of aeration step S2a, the aeration amount calculation unit 73 outputs a change amount calculation command to the measurement device 6. The measurement device 6 receives the change amount calculation command and calculates a first transmembrane pressure difference increase speed R₁. The first transmembrane pressure difference increase speed R₁ is calculated on the basis of the following Expression (1) using a transmembrane pressure difference P₁ measured at the start of aeration step S2a by the pressure measurement unit 61, and a transmembrane pressure difference P₂ measured when the measurement device 6 receives the change amount calculation command.

R₁=(P₂−P₁)/T₁ (1)

The time T₁ is a time needed for calculating the transmembrane pressure difference increase speed, and may be any period of one hour to one day or further one week. The time T₁ may not necessarily be a constant period, but may be changed every time the change amount calculation step is executed.

In recording step S4a, the recording unit 71 records the first transmembrane pressure difference increase speed R₁ and the first target aeration amount Q₁ in association with each other.

In change amount comparing step S5a, the change amount comparing unit 72 compares a transmembrane pressure difference increase speed Rₙ₋₁ which is the change amount of the transmembrane pressure difference before decrease of the aeration amount, calculated for the (n−1)th time in change amount calculation step S3a and recorded in the recording unit 71, and a transmembrane pressure difference increase speed Rₙ which is the change amount of the transmembrane pressure difference after decrease of the aeration amount, calculated for the nth time in change amount calculation step S3a. That is, in the case of n=2, in change amount comparing step S5a, the change amount comparing unit 72 compares the first transmembrane pressure difference increase speed R₁ and a second transmembrane pressure difference increase speed R₂. The change amount comparing unit 72 calculates an aeration amount calculation command and outputs the calculated aeration amount calculation command to the aeration amount calculation unit 73. If the transmembrane pressure difference increase speed Rₙ₋₁ is smaller than the transmembrane pressure difference increase speed Rₙ, the process proceeds to aeration amount determination step S6a, and if the transmembrane pressure difference increase speed Rₙ₋₁ is greater than the transmembrane pressure difference increase speed Rₙ, the process proceeds to aeration amount decrease step S8a.

In the case of n=1, the transmembrane pressure difference increase speed Rₙ₋₁ which is the change amount of the transmembrane pressure difference before decrease of the aeration amount, calculated for the (n−1)th time, does not exist. Therefore, the process proceeds to aeration amount decrease step S8a.

In aeration amount determination step S6a, the aeration amount calculation unit 73 calculates, as a target aeration amount, an aeration amount increased by a predetermined amount or a predetermined rate from the aeration amount recorded in association with the transmembrane pressure difference increase speed Rₙ in the recording unit 71. That is, in the case of n=2, in aeration amount determination step S6a, the aeration amount calculation unit 73 calculates a third target aeration amount Q₃ increased by a predetermined amount or a predetermined rate from a second target aeration amount Q₂.

In aeration step S7a, the aeration amount control unit 74 executes aeration at the target aeration amount Qₙ.

In aeration amount decrease step S8a, the aeration amount calculation unit 73 calculates a second target aeration amount Q₃ which is an aeration amount decreased by a predetermined amount or a predetermined rate from the first target aeration amount Q₁. That is, in the case of n=2, the aeration amount calculation unit 73 calculates a third target aeration amount Q₃ decreased by a predetermined amount or a predetermined rate from the second target aeration amount Q₂.

In addition step S9a, the control device 7 increments n by 1 to set n=n+1, and then returns to aeration step S2a.

Next, the relationship between the change amount of the transmembrane pressure difference per unit time and the aeration amount will be described.

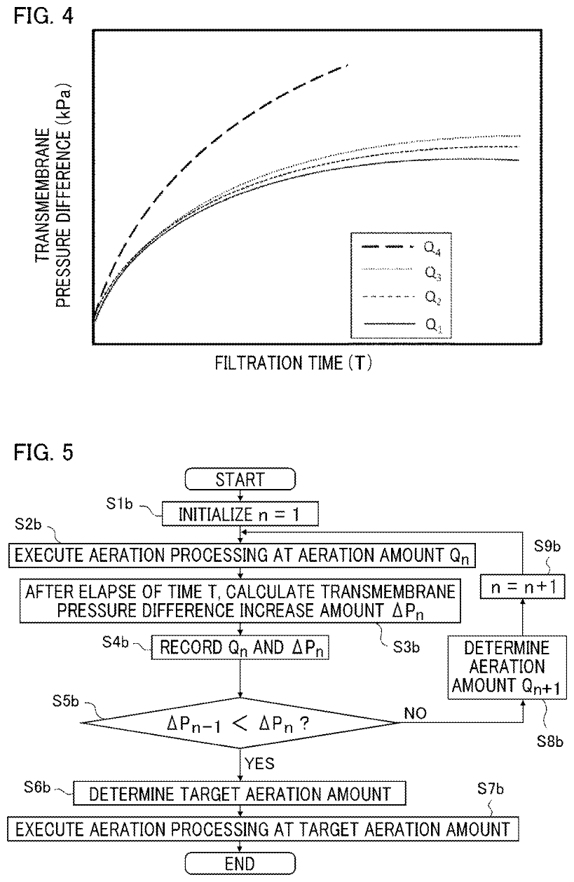

The present inventors have found out through earnest study that there is a relationship as shown in FIG. 4 between the change amount of the transmembrane pressure difference per unit time and the aeration amount.

FIG. 4 illustrates the relationship between the transmembrane pressure difference and the aeration amount. The vertical axis indicates the transmembrane pressure difference (kPa), and the horizontal axis indicates the filtration time (T). The lines in FIG. 4 correspond to different aeration amounts, and Q₂, Q₃, and Q₄ are the aeration amounts sequentially decreased by a certain amount or a certain rate from Q₁. The magnitude order of the aeration amounts is Q₁>Q₂>Q₃>Q₄. As shown in FIG. 4, the transmembrane pressure difference increase speed does not greatly differ among Q₁, Q₂, and Q₃, and sharply increases in Q₄. That is, as shown in FIG. 4, it has been found that, when the aeration amount becomes small, the change amount of the transmembrane pressure difference per unit time (transmembrane pressure difference increase speed) sharply increases. Hereinafter, the point at which the change amount of the transmembrane pressure difference per unit time (transmembrane pressure difference increase speed) sharply increases is referred to as change point.

From FIG. 4, it has been found that executing aeration at an aeration amount greater than the change point merely achieves slight reduction of the transmembrane pressure difference increase speed. That is, if aeration at the change point is executed, the transmembrane pressure difference increase speed is slightly increased as compared to the case of executing aeration at an aeration amount greater than the change point, but since the energy cost needed for aeration is much greater than the operating cost for washing or the like, the whole operating cost of the aeration amount control system is reduced.

According to the control flowchart shown in FIG. 3, in the aeration amount control system 100, if the first transmembrane pressure difference increase speed R₁ is greater than the second transmembrane pressure difference increase speed H₂, a value smaller than the second target aeration amount Q₂ is calculated as the third target aeration amount Q₃, and if the first transmembrane pressure difference increase speed R₁ is smaller than the second transmembrane pressure difference increase speed R₂, a value greater than the second target aeration amount Q₂ is calculated as the third target aeration amount Q₃. That is, the aeration amount control system 100 can execute aeration at the change point through the control flowchart shown in FIG. 3. Thus, the aeration amount control system 100 enables reduction in the whole operating cost of the aeration amount control system.

In the control method of the aeration amount control system 100 shown in FIG. 3, in target aeration step S7a, aeration is continued at the change point corresponding to the target aeration amount calculated in aeration amount determination step S6a. Operation from initialization step S1a to target aeration step S7a shown in FIG. 3 is defined as one change point detection operation. In the control method of the aeration amount control system 100, it is preferable to repeatedly execute this change point detection operation. In the aeration amount control system 100, in the case of executing the change point detection operation for the second time, the target aeration amount Q₁ set in advance may be changed to the target aeration amount calculated in the aeration amount determination step S6a, after the target aeration step S7a, and the predetermined amount or the predetermined rate by which the aeration amount is decreased in aeration amount decrease step S8a may be made smaller than that in the change point detection operation for the first time, thus returning to initialization step S1a. In the change point detection operation for the second time by the aeration amount control system 100, since the predetermined amount or the predetermined rate by which the aeration amount is decreased in aeration amount decrease step S8a is made smaller than that in the change point detection operation for the first time, the change point can be detected more finely.

FIG. 5 is a control flowchart in the aeration amount control system 100. A modification of the aeration amount control method in the aeration amount control system 100 will be described with reference to the control flowchart shown in FIG. 5. In the control flowchart shown in FIG. 3, in change amount calculation step S3a, the transmembrane pressure difference increase speed is calculated, whereas, in the control flowchart shown in FIG. 5, in change amount calculation step S3b, a transmembrane pressure difference increase amount is calculated instead of the transmembrane pressure difference increase speed.

When the filtration process by the aeration amount control system 100 is started, in initialization step S1b, the control device 7 initializes n to 1. Next, in aeration step S2b, the aeration amount calculation unit 73 executes aeration at an aeration amount Q₁ set in advance as the first target aeration amount. As the first target aeration amount Q₁, an optional value is employed from an appropriate range of the aeration amount that enables suppression of fouling of the separation membrane 3. For example, the aeration amount Q₁ is set to the maximum flow amount of the aeration device 5.

In change amount calculation step S3b, when time T has elapsed since the start of aeration step S2b, the aeration amount calculation unit 73 outputs a change amount calculation command to the measurement device 6. The measurement device 6 receives the change amount calculation command and calculates a first transmembrane pressure difference increase amount ΔP₁. The first transmembrane pressure difference increase amount ΔP₁ is calculated on the basis of the following Expression (2) using a transmembrane pressure difference P₁ measured at the start of aeration step S2b by the pressure measurement unit 61, and a transmembrane pressure difference P₂ measured when the measurement device 6 receives the change amount calculation command.

ΔP₁=P₂−P₁ (2)

In recording step S4b, the recording unit 71 records the first transmembrane pressure difference increase amount ΔP₁ and the first target aeration amount Q₁ in association with each other.

In change amount comparing step S5b, the change amount comparing unit 72 compares a transmembrane pressure difference increase amount ΔPₙ₋₁ which is the change amount of the transmembrane pressure difference before decrease of the aeration amount, calculated for the (n−1)th time in change amount calculation step S3b and recorded in the recording unit 71, and a transmembrane pressure difference increase amount ΔPₙ which is the change amount of the transmembrane pressure difference after decrease of the aeration amount, calculated for the nth time in change amount calculation step S3b. That is, in change amount comparing step S5b, in the case of n=2, the change amount comparing unit 72 compares the first transmembrane pressure difference increase amount ΔP₁ and a second transmembrane pressure difference increase amount ΔP₂. The change amount comparing unit 72 calculates an aeration amount calculation command and outputs the calculated aeration amount calculation command to the aeration amount calculation unit 73. If the transmembrane pressure difference increase amount ΔPₙ₋₁ is smaller than the transmembrane pressure difference increase amount ΔPₙ, the process proceeds to aeration amount determination step S6b, and if the transmembrane pressure difference increase amount ΔPₙ₋₁ is greater than the transmembrane pressure difference increase amount ΔPₙ, the process proceeds to aeration amount decrease step S8b.

In the case of n=1, the transmembrane pressure difference increase amount ΔPₙ₋₁ which is the change amount of the transmembrane pressure difference before decrease of the aeration amount, calculated for the (n−1)th time, does not exist. Therefore, the process proceeds to aeration amount decrease step S8b.

In aeration amount determination step S6b, the aeration amount calculation unit 73 calculates, as the target aeration amount Qₙ, an aeration amount increased by a predetermined amount or a predetermined rate from the aeration amount recorded in association with the transmembrane pressure difference increase amount ΔPₙ₋₁ in the recording unit 71. That is, in the case of n=2, the aeration amount calculation unit 73 calculates a third target aeration amount Q₃ increased by a predetermined amount or a predetermined rate from the second target aeration amount Q₂.

In target aeration step S7b, the aeration amount control unit 74 executes aeration at the target aeration amount Qₙ.

In aeration amount decrease step S8b, the aeration amount calculation unit 73 calculates a second target aeration amount Q₂ which is an aeration amount decreased by a predetermined amount or a predetermined rate from the first target aeration amount Q₁. That is, in the case of n=2, the aeration amount calculation unit 73 calculates a third target aeration amount Q₃ decreased by a predetermined amount or a predetermined rate from the second target aeration amount Q₂.

In addition step S9b, the control device 7 increments n by 1 to set n=n+1, and then returns to aeration step S2b.

The aeration amount control system according to embodiment 1 is an aeration amount control system for performing aeration for a separation membrane in a membrane separation tank storing treatment target water on the basis of a target aeration amount, the aeration amount control system including: a control device for determining a first target aeration amount as the target aeration amount, and after having determined the first target aeration amount, determining a second target aeration amount as the target aeration amount; an aeration device for performing aeration by supplying gas on the basis of the target aeration amount determined by the control device; and a measurement device for measuring a change amount of a transmembrane pressure difference of the separation membrane with respect to the gas supplied by the aeration device, wherein, if a first change amount of the transmembrane pressure difference of the separation membrane during the aeration performed on the basis of the first target aeration amount by the aeration device, calculated by the measurement device, is greater than a second change amount of the transmembrane pressure difference of the separation membrane during aeration performed on the basis of the second target aeration amount by the aeration device, calculated by the measurement device, the control device determines a value smaller than the second target aeration amount, as a third target aeration amount.

With the above configuration, the aeration amount control system 100 according to embodiment 1 enables reduction in the energy cost needed for aeration through increase/decrease of the target value for the aeration amount, and thus can reduce the whole operating cost of the aeration amount control system.

The aeration amount control method according to embodiment 1 is performed in an aeration amount control system for performing aeration for a separation membrane in a membrane separation tank storing treatment target water on the basis of a target aeration amount, the aeration amount control method including: an aeration amount determination step of determining a first target aeration amount as the target aeration amount, and after having determined the first target aeration amount, determining a second target aeration amount as the target aeration amount; an aeration step of performing the aeration by supplying gas on the basis of the target aeration amount determined in the aeration amount determination step; and a change amount calculation step of calculating a change amount of a transmembrane pressure difference of the separation membrane with respect to the gas supplied in the aeration step, wherein, if a first change amount of the transmembrane pressure difference of the separation membrane during the aeration performed on the basis of the first target aeration amount, calculated by the measurement device, is greater than a second change amount of the transmembrane pressure difference of the separation membrane during the aeration performed on the basis of the second target aeration amount, calculated by the measurement device, a value smaller than the second target aeration amount is determined as a third target aeration amount.

With the above configuration, the aeration amount control method in the aeration amount control system 100 according to embodiment 1 enables reduction in the energy cost needed for aeration through increase/decrease of the target value for the aeration amount, and thus can reduce the whole operating cost of the aeration amount control system.

### Embodiment 2

The configuration of an aeration amount control system 200 according to embodiment 2 of the present invention will be described. It is noted that the same or corresponding configurations as those in embodiment 1 will not be described and only different configuration parts will be described.

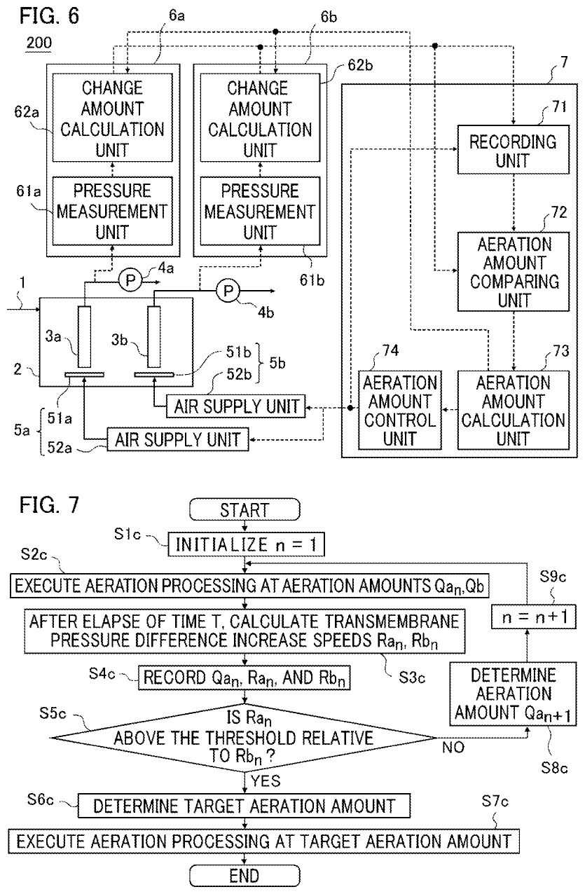

FIG. 6 is a configuration diagram of the aeration amount control system 200. The aeration amount control system 200 includes pluralities of separation membranes 3, filtration pumps 4, aeration pipes 51, air supply units 52, pressure measurement units 61, and change amount calculation units 62. It is noted that units having the same function are denoted by the same numerals followed by a, b. The other configurations are the same as those in embodiment 1, and therefore the same or corresponding parts are denoted by the same reference characters and description thereof is omitted. It is noted that the filtration system with reference numerals followed by a is defined as filtration system a, and the filtration system with reference numerals followed by b is defined as filtration system b.

Change amount calculation units 62a, 62b calculate the change amounts of the transmembrane pressure differences per unit time in their respective systems at the same timing.

The recording unit 71 is connected to the change amount calculation units 62a, 62b and the aeration amount control unit 74. The recording unit 71 records the change amount of the transmembrane pressure difference per unit time calculated by the change amount calculation unit 62a and the aeration amount in the filtration system a subjected to aeration control by the aeration amount control unit 74 at the time when the change amount of the transmembrane pressure difference per unit time is calculated by the change amount calculation unit 62a, in association with each other. In addition, the recording unit 71 records the change amount of the transmembrane pressure difference per unit time calculated by the change amount calculation unit 62b and the aeration amount in the filtration system b subjected to aeration control by the aeration amount control unit 74 at the time when the change amount of the transmembrane pressure difference per unit time is calculated by the change amount calculation unit 62b, in association with each other.

The change amount comparing unit 72 performs comparison as to whether or not a first-system-a change amount which is the change amount per unit time calculated in the filtration system a is smaller than a threshold relative to a first-system-b change amount which is the change amount of the transmembrane pressure difference per unit time calculated in the filtration system b at the same timing as in the filtration system a. The change amount comparing unit 72 calculates an aeration amount calculation command and outputs the calculated aeration amount calculation command to the aeration amount calculation unit 73. The aeration amount calculation command is information which includes a result of comparison of the change amounts by the change amount comparing unit 72 and which is used for the aeration amount calculation unit 73 to calculate the aeration amount. The threshold used for comparison by the change amount comparing unit 72 is determined in accordance with the applied aeration amount control system.

The aeration amount calculation unit 73 calculates target aeration amounts for aeration devices 5a, 5b on the basis of the received aeration amount calculation command, and outputs the target aeration amounts to the aeration amount control unit 74. If the comparison result from the change amount comparing unit 72 is smaller than the threshold, the aeration amount calculation unit 73 sets the target aeration amount for the aeration device 5a, to an aeration amount decreased by a predetermined amount or a predetermined rate from the first-system-a change amount, and does not change the aeration amount for the aeration device 5b. If the comparison result from the change amount comparing unit 72 is equal to or greater than the threshold, the aeration amount calculation unit 73 sets the target aeration amounts for the aeration device 5a and the aeration device 5b, to an aeration amount increased by a predetermined amount or a predetermined rate from the first-system-a change amount.

The aeration amount control unit 74 controls supply of air by air supply units 52a, 52b so that the aeration amounts of the aeration devices 5a, 5b become the respective target aeration amounts determined by the aeration amount calculation unit 73.

FIG. 7 is a control flowchart in the aeration amount control system 200. The aeration amount control method in the aeration amount control system 200 will be described with reference to the control flowchart shown in FIG. 7.

When the filtration process by the aeration amount control system 200 is started, in initialization step S1c, the control device 7 initializes n to 1. Next, in aeration step S2c, the control device 7 executes aeration at an aeration amount Qa₁ set in advance as the first-system-a target aeration amount in the filtration system a, and aeration at an aeration amount Qb set in advance as the first-system-b target aeration amount in the filtration system b. As the aeration amounts Qa₁, Qb, optional values are employed from an appropriate range of the aeration amount that enables suppression of fouling of the separation membrane 3. The aeration amount Qa₁, Qb set in advance are the same value, and, for example, are set to the maximum flow amount of the aeration devices 5a, 5b.

When time T has elapsed since the start of aeration step S2c, in change amount calculation step S3c, the change amount calculation unit 62a calculates a first-system-a transmembrane pressure difference increase speed Ra₁, and the change amount calculation unit 62b calculates a first-system-b transmembrane pressure difference increase speed Rb₁. The first-system-a transmembrane pressure difference increase speed Ra₁ and the first-system-b transmembrane pressure difference increase speed Rb₁ are calculated in the respective filtration systems on the basis of Expression (1).

In recording step S4c, the recording unit 71 records the aeration amount Qa₁, the first-system-a transmembrane pressure difference increase speed Ra₁, and the first-system-b transmembrane pressure difference increase speed Rb₁ in association with each other.

In change amount comparing step S5c, the change amount comparing unit 72 determines whether or not the ratio of a transmembrane pressure difference increase speed Raₙ calculated for the nth time in the filtration system a relative to a transmembrane pressure difference increase speed Rbₙ calculated for the nth time in the filtration system b in aeration amount calculation step S3c is equal to or greater than a threshold. The change amount comparing unit 72 calculates an aeration amount calculation command and outputs the calculated aeration amount calculation command to the aeration amount calculation unit 73. If the transmembrane pressure difference increase speed Raₙ is equal to or greater than the threshold relative to the transmembrane pressure difference increase speed Rbₙ, the process proceeds to aeration amount determination step S6c, and if the transmembrane pressure difference increase speed Raₙ is smaller than the threshold relative to the transmembrane pressure difference increase speed Rbₙ, the process proceeds to aeration amount decrease step S8c.

In the case of n=1, since the aeration amounts Qa₁, Qb set in advance are the same value, the first-system-a transmembrane pressure difference increase speed Ra₁ and the first-system-b transmembrane pressure difference increase speed Rb₁ are regarded as being not different from each other, and thus the process proceeds to aeration amount decrease step S8c.

In aeration amount determination step S6c, the aeration amount calculation unit 73 calculates, as the target aeration amount Qₙ for the filtration system a and the filtration system b, an aeration amount increased by a predetermined amount or a predetermined rate from the aeration amount recorded in association with the transmembrane pressure difference increase speed Raₙ in the recording unit 71.

In aeration step S7c, the aeration amount control unit 74 executes aeration at the target aeration amount in the filtration system a and the filtration system b.

In aeration amount decrease step S8c, the aeration amount calculation unit 73 calculates, as the target aeration amount for the filtration system a, a second target aeration amount Q₂ which is an aeration amount decreased by a predetermined amount or a predetermined rate from the aeration amount recorded in association with the transmembrane pressure difference increase speed Raₙ in the recording unit 71. That is, in the case of n=2, the aeration amount calculation unit 73 calculates a third target aeration amount Q₃ decreased by a predetermined amount or a predetermined rate from the second target aeration amount as the target aeration amount for the filtration system a.

In addition step S9c, the control device 7 increments n by 1 to set n=n+1, and then returns to aeration step S2c.

In the aeration amount control method in the aeration amount control system 200 shown in FIG. 7, the transmembrane pressure difference increase amount may be calculated instead of the transmembrane pressure difference increase speed. By applying the aeration amount control method in the aeration amount control system 100 shown in FIG. 5 to the aeration amount control method in the aeration amount control system 200 shown in FIG. 7, it is possible to execute control on the basis of the transmembrane pressure difference increase amount also in the aeration amount control system 200.

The aeration amount control system according to embodiment 2 is an aeration amount control system for performing aeration for a plurality of separation membranes in a membrane separation tank storing treatment target water on the basis of a target aeration amount, the aeration amount control system including: a control device for determining a first target aeration amount as the target aeration amount; an aeration device for performing aeration by supplying gas on the basis of the target aeration amount determined by the control device; and a measurement device for measuring change amounts of transmembrane pressure differences of the plurality of separation membranes with respect to the gas supplied by the aeration device, wherein, if a difference of respective first change amounts of the plurality of separation membranes during the aeration performed on the basis of the first target aeration amount by the aeration device, calculated by the measurement device, is smaller than a threshold, the control device determines a value smaller than the first target aeration amount, as a second target aeration amount.

With the above configuration, the aeration amount control system 200 according to embodiment 2 can execute control of the aeration amount using one of the plurality of provided separation membranes. Therefore, the aeration amount for the separation membrane other than the separation membrane used for the control need not be changed, and while fouling of the separation membrane other than the separation membrane used for the control is suppressed, the energy cost needed for aeration can be reduced through increase/decrease of the target value for the aeration amount, whereby the whole operating cost of the aeration amount control system can be reduced.

### Embodiment 3

The configuration of an aeration amount control system 300 according to embodiment 3 of the present invention will be described. It is noted that the same or corresponding configurations as those in embodiment 1 will not be described and only different configuration parts will be described.

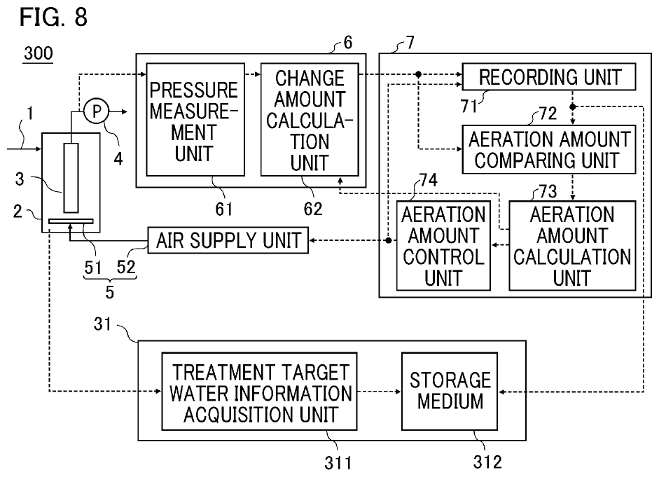

FIG. 8 is a configuration diagram of the aeration amount control system 300. The aeration amount control system 300 includes an information acquisition device 31 which acquires and stores treatment target water information. The information acquisition device 31 includes a treatment target water information acquisition unit 311 for acquiring treatment target water information and a storage medium 312 for storing the treatment target water information.

The treatment target water information acquisition unit 311 acquires, as treatment target water information, for example, the water temperature of the treatment target water 1 in the membrane separation tank 2, the mixed liquor suspended solid (MLSS) concentration, the turbidity of the treatment target water 1, the suspended solid (SS) concentration, the filtration flux of the separation membrane 3, the organic substance concentration in the treatment target water 1, etc.

The water temperature of the treatment target water 1 in the membrane separation tank 2 is measured by providing a water temperature sensor to the membrane separation tank 2. The water temperature of the treatment target water 1 in the membrane separation tank 2 may be measured by supplying the treatment target water 1 to a water temperature sensor.

The turbidity, the MLSS concentration, and the SS concentration of the treatment target water 1 are measured by providing an MLSS concentration sensor, a turbidity meter, etc., to the membrane separation tank 2. The turbidity, the MLSS concentration, and the SS concentration of the treatment target water 1 may be measured by supplying the treatment target water 1 to an MLSS concentration sensor, a turbidity meter, etc. The treatment target water 1 may be extracted and the MLSS concentration, the SS concentration, the turbidity, etc., thereof may be measured through manual analysis.

The filtration flux of the separation membrane 3 is measured by providing a flow rate sensor to the filtered water pipe. The filtration flux can be measured by measuring the filtered water amount per constant time to calculate the flow rate and dividing the flow rate value by the membrane area of the separation membrane 3.

The organic substance concentration, etc., in the treatment target water 1 are measured by immersing an organic substance concentration sensor such as a total organic carbon concentration meter, an ultraviolet absorbance meter, or a fluorescence intensity meter in the membrane separation tank 2. The organic substance concentration, etc., in the treatment target water 1 may be measured by supplying the treatment target water 1 in the membrane separation tank 2 to such an organic substance concentration sensor. That is, the organic substance in the water may be measured directly or indirectly using a total organic carbon concentration meter, an ultraviolet absorbance meter, a fluorescence intensity meter, or the like.

The storage medium 312 stores the treatment target water information acquired by the treatment target water information acquisition unit 311 and the aeration amount information recorded in the recording unit 71, in association with each other.

As the water temperature is lowered, viscosity of the water increases, and therefore the change amount of the transmembrane pressure difference per unit time increases. In addition, as the MLSS concentration, the SS concentration, the turbidity, or the like increases, the separation membrane 3 becomes more likely to be clogged, and therefore the change amount of the transmembrane pressure difference per unit time increases. In addition, as the filtration flux increases, the speed at which water passes through the separation membrane 3 increases and the separation membrane 3 becomes more likely to be clogged, and therefore the change amount of the transmembrane pressure difference per unit time increases. Organic substances which can cause clogging of the separation membrane 3 can be accurately measured by measuring, as an organic substance index for the treatment target water 1, for example, ultraviolet (UV), total organic carbon (TOC), chemical oxygen demand (COD), biochemical oxygen demand (BOD), humic acid concentration, sugar concentration, protein concentration, or the like.

Next, operation of the aeration amount control system 300 according to embodiment 3 will be described. It is noted that the same or corresponding configurations as those in embodiment 1 will not be described and only different configuration parts will be described.

In the aeration amount control system 300, the storage medium 312 stores the treatment target water information acquired by the treatment target water information acquisition unit 311 and the aeration amount information stored in the recording unit 71 in association with each other, thereby generating a database.

In addition, the information acquisition device 31 may have a function of determining that the state of the treatment target water 1 has greatly changed, and a function of estimating an appropriate aeration amount at the time when the state of the treatment target water 1 has greatly changed, through checking against the treatment target water information stored in the generated database, and setting the estimated aeration amount as a target aeration amount.

In the case where the information acquisition device 31 has the above functions, the aeration amount control system 300 can perform operation of, when the state of the treatment target water 1 in the membrane separation tank 2 has greatly changed, checking the changed treatment target water information against the treatment target water information stored in the generated database, estimating an appropriate aeration amount at the time when the state of the treatment target water 1 has greatly changed, and setting the estimated aeration amount as a target aeration amount.

Even in the case where data corresponding to the state of the treatment target water 1 at the time when the state of the treatment target water 1 has greatly changed is not stored in the database, an appropriate aeration amount in the state of the treatment target water 1 at the time when the state of the treatment target water has greatly changed can be estimated from data stored in the database. For example, in the case where the database includes data corresponding to water temperature of 10° C. and water temperature of 30° C. and the water temperature of the treatment target water 1 at the time when the state of the treatment target water 1 has greatly changed is 20° C., an appropriate aeration amount can be estimated as the average value between the aeration amounts in the data corresponding to water temperature of 10° C. and water temperature of 30° C. Further, it is possible to generate a more detailed database by updating the database along with operation of the aeration amount control system 300.

The aeration amount control system 300 according to embodiment 3 includes a treatment target water information acquisition unit for acquiring treatment target water information about treatment target water in the membrane separation tank, and a storage medium for storing the treatment target water information, the target aeration amount calculated by the control device, and a change amount of a transmembrane pressure difference measured by the measurement device, in association with each other.

With the above configuration, the aeration amount control system 300 according to embodiment 3 can quickly calculate a target aeration amount using data stored in the database even when the state of the treatment target water 1 in the membrane separation tank 2 has greatly changed.

The present invention is not limited to the configurations described in embodiments 1 to 3, and within the scope of the present invention, the above embodiments may be freely combined with each other or each embodiment may be modified or simplified as appropriate.

While the embodiments of the present invention have been described above, the embodiments disclosed herein are illustrative in all aspects and are not intended to be restrictive. The scope of right of the present invention is indicated by the scope of claims and is intended to include all modifications within the meaning and the scope equivalent to the scope of claims.

### DESCRIPTION OF THE REFERENCE CHARACTERS

100, 200, 300 aeration amount control system
1 treatment target water
2 membrane separation tank
3 separation membrane
4 filtration pump
5 aeration device
6 measurement device
7 control device
31 information acquisition device
51 aeration pipe
52 air supply unit
61 pressure measurement unit
62 change amount calculation unit
71 recording unit
72 change amount comparing unit
73 aeration amount calculation unit
74 aeration amount control unit
311 treatment target water information acquisition
unit
312 storage medium
1000a, 1000b CPU
1001a, 1001b memory

1. An aeration amount control system for performing aeration for a separation membrane in a membrane separation tank storing treatment target water on the basis of a target aeration amount, the aeration amount control system comprising:
a control device for determining a first target aeration amount as the target aeration amount, and after having determined the first target aeration amount, determining a second target aeration amount as the target aeration amount;
an aeration device for performing the aeration by supplying gas on the basis of the target aeration amount determined by the control device; and
a measurement device for calculating a change amount of a transmembrane pressure difference of the separation membrane with respect to the gas supplied by the aeration device, wherein
if a first change amount of the transmembrane pressure difference of the separation membrane calculated by the measurement device for the aeration performed on the basis of the first target aeration amount by the aeration device is greater than a second change amount of the transmembrane pressure difference of the separation membrane calculated by the measurement device for the aeration performed on the basis of the second target aeration amount by the aeration device, the control device determines a value smaller than the second target aeration amount, as a third target aeration amount.

2. The aeration amount control system according to claim 1, wherein
if the first change amount is smaller than the second change amount, the control device determines a value greater than the second target aeration amount, as the third target aeration amount.

3. An aeration amount control system for performing aeration for a plurality of separation membranes in a membrane separation tank storing treatment target water on the basis of a target aeration amount, the aeration amount control system comprising:
a control device for determining a first target aeration amount as the target aeration amount;
an aeration device for performing the aeration by supplying gas on the basis of the target aeration amount determined by the control device; and
a measurement device for calculating change amounts of transmembrane pressure differences of the plurality of separation membranes with respect to the gas supplied by the aeration device, wherein
if a difference between respective first change amounts of the transmembrane pressure differences of the plurality of separation membranes during the aeration performed on the basis of the first target aeration amount by the aeration device, calculated by the measurement device, is smaller than a threshold, the control device determines a value smaller than the first target aeration amount, as a second target aeration amount.

4. The aeration amount control system according to claim 3, wherein
if the difference between the respective first change amounts is equal to or greater than the threshold, the control device determines a value greater than the first target aeration amount, as the second target aeration amount.

5. The aeration amount control system according to claim 1, further comprising an information acquisition device including
a treatment target water information acquisition unit for acquiring treatment target water information about the treatment target water in the membrane separation tank, and
a storage medium for storing the treatment target water information, the target aeration amount determined by the control device, and the change amount of the transmembrane pressure difference calculated by the measurement device, in association with each other.

6. An aeration amount control method for performing aeration for a separation membrane in a membrane separation tank storing treatment target water on the basis of a target aeration amount, the aeration amount control method comprising:
an aeration amount determination step of determining a first target aeration amount as the target aeration amount, and after having determined the first target aeration amount, determining a second target aeration amount as the target aeration amount;
an aeration step of performing the aeration by supplying gas on the basis of the target aeration amount determined in the aeration amount determination step; and
a change amount calculation step of calculating a change amount of a transmembrane pressure difference of the separation membrane with respect to the gas supplied in the aeration step, wherein
if a first change amount of the transmembrane pressure difference of the separation membrane calculated for the aeration performed on the basis of the first target aeration amount is greater than a second change amount of the transmembrane pressure difference of the separation membrane calculated for the aeration performed on the basis of the second target aeration amount, a value smaller than the second target aeration amount is determined as a third target aeration amount.

7. The aeration amount control method according to claim 6, wherein
if the first change amount is smaller than the second change amount, a value greater than the second target aeration amount is determined as the third target aeration amount.

8. The aeration amount control system according to claim 3, further comprising an information acquisition device including
a treatment target water information acquisition unit for acquiring treatment target water information about the treatment target water in the membrane separation tank, and
a storage medium for storing the treatment target water information, the target aeration amount determined by the control device, and the change amount of the transmembrane pressure difference calculated by the measurement device, in association with each other.

9. An aeration amount control method for performing aeration for a plurality of separation membranes in a membrane separation tank storing treatment target water on the basis of a target aeration amount, the aeration amount control method comprising:
an aeration amount determination step of determining a first target aeration amount as the target aeration amount;
an aeration step of performing the aeration by supplying gas on the basis of the target aeration amount determined in the aeration amount determination step; and
a change amount calculation step of calculating change amounts of transmembrane pressure differences of the plurality of separation membranes with respect to the gas supplied in the aeration step, wherein
if a difference between respective first change amounts of the transmembrane pressure differences of the plurality of separation membranes during the aeration performed on the basis of the first target aeration amount is smaller than a threshold, a value smaller than the first target aeration amount is determined as a second target aeration amount.

10. The aeration amount control method according to claim 9, wherein
if the difference between the respective first change amounts is equal to or greater than the threshold, a value greater than the first target aeration amount is determined as the second target aeration amount.
